(19) United States
(12) Patent Application Publication
(10) Pub. No.: US 2025/0322298 A1
(43) Pub. Date: Oct. 16, 2025

(54) Distillation of Multi-Sample Preference sampling Processes for Sequence Processing Models

(71) Applicant: DeepMind Technologies Limited, London (GB)

(72) Inventors: Olivier Frédéric Bachem, Zurich (CH); Pier Giuseppe Sessa, Zurich (CH); Léonard Hussenot, Paris (FR); Johan Ferret, Paris (FR); Robert Dadashi-Tazehozi, Paris (FR); Nino Jean Vieillard, Paris (FR); Sertan Girgin, Chamonix-Mont Blank (FR)

(21) Appl. No.: 18/635,782

(22) Filed: Apr. 15, 2024

(51) Int. Cl. G06N 20/00

(52) U.S. Cl. CPC G06N 20/00

(57) ABSTRACT

Provided are analytical expressions for multi-sample preference sampling distributions. A distillation training approach can be framed as a distribution matching problem with respect to one of these analytical expressions. The distribution matching problem can be solved using various algorithms. For example, a student model can be finetuned via policy distillation techniques. The resulting student model is therefore able to provide the benefits of the multi-sample preference sampling process, including its robustness and ability to align with human preferences, while significantly reducing the computational overhead at inference time.

### BACKGROUND

A computer can receive input(s). The computer can execute instructions to process the input(s) to generate output(s) using a parameterized model. In one example, the input can be a query and the output can be a response to the query. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

One type of machine learning model is a neural network. Neural networks employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

Aspects and advantages of embodiments of the present disclosure will be set forth in part in the following description, or can be learned from the description, or can be learned through practice of the embodiments.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One example aspect of the present disclosure is directed to a computer-implemented method for distilling a multi-sample preference sampling distribution into a student sequence processing model. The method includes obtaining, by a computing system comprising one or more computing devices, a token sequence that is responsive to an input context. The method includes determining, by the computing system, a student distribution of the student sequence processing model for the token sequence, wherein the student distribution characterizes a likelihood that the student sequence processing model generates the token sequence given the input context. The method includes estimating, by the computing system and using the token sequence, the multi-sample preference sampling distribution for the token sequence, wherein the multi-sample preference sampling distribution characterizes a likelihood that the token sequence is returned by a multi-sample preference sampling process applied to a reference sequence processing model given the input context. The method includes evaluating, by the computing system, a distribution matching loss that penalizes one or more divergence metrics between the student distribution and the multi-sample preference sampling distribution. The method includes modifying, by the computing system, one or more values of one or more parameters of the student sequence processing model based on the evaluating of the distribution matching loss. Other embodiments of this aspect include corresponding computer systems, apparatus, and computer programs recorded on one or more computer storage devices, each configured to perform the actions of the methods.

Additional example implementations may include any combination of one or more of the following features. The computer-implemented method where the multi-sample preference sampling process may include: generation of a plurality of candidate samples from the reference sequence processing model given the input context; and application of a preference model to generate an output sample from the plurality of candidate samples. The multi-sample preference sampling process may include a Best-of-N sampling process. The application of the preference model in the Best-of-N sampling process may include: evaluation of each of the plurality of candidate samples with a reward model to generate a reward score for each of the plurality of candidate samples, where the reward model has been trained on preference label data; and selection of the candidate sample with the largest reward score as the output sample. The multi-sample preference sampling distribution may include a reference sampling distribution associated with the reference sequence processing model times a reweighting term, where the reweighting term evaluates a preference value for the token sequence based on the preference model. The multi-sample preference sampling distribution may include a Best-of-N sampling distribution, and where the Best-of-N sampling distribution may include a reference sampling distribution associated with the reference sequence processing model times a reweighting term times a correction factor, where the reweighting term evaluates a reward quantile for the token sequence. Estimating, by the computing system, the Best-of-N sampling distribution for the token sequence may include performing, by the computing system, a Monte Carlo estimate of the reward quantile for the token sequence. Performing, by the computing system, the Monte Carlo estimate of the reward quantile for the token sequence may include: sampling, by the computing system, a number of random sequences from the reference sequence processing model; and determining, by the computing system, the reward quantile for the token sequence based on an amount of the number of random sequences for which a reward generated for the token sequence by a reward model is greater than or equal to a respective reward generated for the random sequence by the reward model. Estimating, by the computing system, the Best-of-N sampling distribution for the token sequence may include processing, by the computing system, the token sequence with a machine-learned quantile estimation model to generate an estimate of the reward quantile for the token sequence. The machine-learned quantile estimation model may have been initialized from the reference sequence processing model. The machine-learned quantile estimation model may have been trained using binary cross-entropy loss on actual reward outcomes. Processing, by the computing system, the token sequence with the machine-learned quantile estimation model may include determining, by the computing system, a sigmoid of a token-length-normalized sum of logit values of the reference sequence processing model for the token sequence. The one or more divergence metrics may include one or more F-divergences. The one or more divergence metrics may include a backward KL divergence metric between the student distribution and the multi-sample preference sampling distribution. The one or more divergence metrics may include a Jeffrey's divergence metric between the student distribution and the multi-sample preference sampling distribution. Evaluating, by the computing system, the distribution matching loss and modifying, by the computing system, the one or more values of the one or more parameters of the student sequence processing model based on the evaluating of the distribution matching loss may include: performing, by the computing system, a reinforcement learning algorithm to optimize the distribution matching loss. Evaluating, by the computing system, the distribution matching loss and modifying, by the computing system, the one or more values of the one or more parameters of the student sequence processing model based on the evaluating of the distribution matching loss may include: performing, by the computing system, an offline regression algorithm to optimize the distribution matching loss. The method further may include, while iteratively performing the operations: periodically updating, by the computing system, the reference sequence processing model based on a current version of the student sequence processing model. Periodically updating, by the computing system, the reference sequence processing model based on the current version of the student sequence processing model may include periodically setting, by the computing system, the reference sequence processing model equal to the current version of the student sequence processing model. Periodically updating, by the computing system, the reference sequence processing model based on the current version of the student sequence processing model may include periodically updating, by the computing system, the reference sequence processing model based on a moving average of parameter values of the student sequence processing model. The moving average may include an exponential moving average. The computer-implemented method may include initializing, by the computing system, the student sequence processing model from the reference sequence processing model. The student sequence processing model may have a smaller number of parameters than the reference sequence processing model. Implementations of the described techniques may include hardware, a method or process, or computer software on a computer-accessible medium.

Another example aspect of the present disclosure is directed to a computing system configured to perform sequence processing model alignment. The computing system comprises one or more computing devices and is configured to perform operations. The operations include obtaining a student sequence processing model. The operations include performing a plurality of update iterations to update the student sequence processing model. Each of the update iterations comprises: evaluating a distribution matching loss for one or more token sequences that are responsive to one or more context inputs, wherein the distribution matching loss seeks to minimize one or more divergence metrics between a student distribution that is associated with the student sequence processing model and a multi-sample preference sampling distribution that is representative of a multi-sample preference sampling process applied to a reference sequence processing model; and modifying one or more values of one or more parameters of the student sequence processing model based on the evaluating of the distribution matching objective. The operations include periodically, while performing the plurality of update iterations, updating the reference sequence processing model based on a current version of the student sequence processing model. Other embodiments of this aspect include corresponding computer systems, apparatus, and computer programs recorded on one or more computer storage devices, each configured to perform the described aspect.

Additional example implementations may include any combination of one or more of the following features. The computing system where periodically updating, by the computing system, the reference sequence processing model based on the current version of the student sequence processing model may include periodically setting, by the computing system, the reference sequence processing model equal to the current version of the student sequence processing model. Periodically updating, by the computing system, the reference sequence processing model based on the current version of the student sequence processing model may include periodically updating, by the computing system, the reference sequence processing model based on a moving average of parameter values of the student sequence processing model. The moving average may include an exponential moving average. Implementations of the described techniques may include hardware, a method or process, or computer software on a computer-accessible medium.

Another example aspect of the present disclosure is directed to one or more non-transitory computer-readable media that collectively store a student sequence processing model that has been trained by performance of training operations. The training operations include obtaining, by a computing system comprising one or more computing devices, a token sequence that is responsive to an input context. The training operations include determining, by the computing system, a student distribution of the student sequence processing model for the token sequence, wherein the student distribution characterizes a likelihood that the student sequence processing model generates the token sequence given the input context. The training operations include estimating, by the computing system and using the token sequence, a multi-sample preference sampling distribution for the token sequence, wherein the multi-sample preference sampling distribution characterizes a likelihood that the token sequence is returned by a multi-sample preference sampling process applied to a reference sequence processing model given the input context. The training operations include evaluating, by the computing system, a distribution matching loss that penalizes one or more divergence metrics between the student distribution and the multi-sample preference sampling distribution. The training operations include modifying, by the computing system, one or more values of one or more parameters of the student sequence processing model based on the evaluating of the distribution matching loss. Other embodiments of this aspect include corresponding computer systems, apparatus, and computer programs recorded on one or more computer storage devices, each configured to perform the described aspect.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

FIG. 1 illustrates a flowchart diagram of an example computer-implemented method for distilling a multi-sample preference sampling distribution into a student sequence processing model according to example implementations of aspects of the present disclosure.

FIG. 2 illustrates a flowchart diagram of an example computer-implemented method for iteratively distilling a multi-sample preference sampling distribution into a student sequence processing model according to example implementations of aspects of the present disclosure.

FIG. 3 is a flow chart diagram illustrating an example method for training a machine-learned model according to example implementations of aspects of the present disclosure;

FIG. 4 is a block diagram of an example processing flow for using machine-learned model(s) to process input(s) to generate output(s) according to example implementations of aspects of the present disclosure;

FIG. 5 is a block diagram of an example sequence processing model according to example implementations of aspects of the present disclosure;

FIG. 6 is a block diagram of an example technique for populating an example input sequence for processing by a sequence processing model according to example implementations of aspects of the present disclosure;

FIG. 7 is a block diagram of an example model development platform according to example implementations of aspects of the present disclosure;

FIG. 8 is a block diagram of an example training workflow for training a machine-learned model according to example implementations of aspects of the present disclosure;

FIG. 9 is a block diagram of an inference system for operating one or more machine-learned model(s) to perform inference according to example implementations of aspects of the present disclosure;

FIG. 10 is a block diagram of an example networked computing system according to example implementations of aspects of the present disclosure;

FIG. 11 is a block diagram of an example computing device according to example implementations of aspects of the present disclosure; and

FIG. 12 is a block diagram of an example computing device according to example implementations of aspects of the present disclosure.

### DETAILED DESCRIPTION

Example aspects of the present disclosure are directed to approaches for “distilling” a multi-sample preference sampling distribution to a student model. In particular, a multi-sample preference sampling distribution is a sampling distribution that characterizes a likelihood that a token sequence is returned by a multi-sample preference sampling process applied to a reference sequence processing model given an input context.

One example of a multi-sample preference sampling process is the Best-of-N sampling process. In the Best-of-N sampling process, N candidate samples are generated, and each is scored by a reward model trained to reflect human preferences. The candidate with the highest score, indicating the best alignment with the reward model, is then selected as the final output.

The distillation approaches described herein include training the student model to imitate the multi-sample preference sampling process. By distilling the multi-sample preference sampling distribution to the student model, the student model behaves like the multi-sample preference sampling process, but only requires a single sample. Thus, the proposed distillation approaches provide the benefits of the multi-sample preference sampling process without the corresponding increase in computational operations. Therefore, the proposed approach represents an improvement in the alignment of the model with reduced computational cost.

More particularly, the field of artificial intelligence (AI) has seen remarkable advancements in recent years, particularly in the development of a group of generative models which can be referred to as sequence processing models. A sequence processing model is a type of machine learning model designed to process and/or generate sequences of data, such as text, audio, and/or image sequences. Example types of sequence processing models includes Large Language Models (LLMs), which specialize in handling and generating human language text sequences, as well as Large Multi-Modal Models (LMMs), which can process and integrate multiple forms of data, such as combining textual, auditory, and visual inputs, to perform a variety of complex tasks that require an understanding of different data modalities in a cohesive manner.

A fundamental challenge in the deployment of LLMs or other sequence processing models is ensuring that the output (e.g., the generated text) aligns with human preferences and intentions. This alignment is important to the utility and acceptability of the models' outputs. Traditional methods for aligning LLMs with human preferences have involved training a reward model from preference data, which is then used to fine-tune the LLM using deep reinforcement learning from human feedback (RLHF). However, RLHF has been associated with several issues, including distribution shifts that lead to reward misspecification, as well as reward hacking, where the LLM learns to exploit the reward model in unintended ways. These challenges make RLHF difficult to tune and potentially harmful to the performance and reliability of the LLM.

A different approach to improve alignment is the use of a multi-preference sampling process. A multi-preference sampling process is a method used in machine learning and artificial intelligence that involves generating multiple candidate samples in response to a given input and subsequently generating a final output based on these candidates. For example, one of the candidate samples can be selected as the output sample. The selection is typically made through the application of a preference model, which evaluates each candidate according to certain criteria or other measures of preference that reflect desired attributes or outcomes. This process aims to produce an output that is more closely aligned with specified preferences or objectives than would be likely from a single, random sample.

One example of a multi-preference sampling process is the Best-of-N sampling process. In the Best-of-N sampling process, N candidate samples are generated, and each is scored by a reward model trained to reflect human preferences. The candidate with the highest score, indicating the best alignment with the reward model, is then selected as the final output. This approach is particularly useful in scenarios where the quality of the output is critical, and a single generation may not yield the optimal result.

However, while Best-of-N sampling can improve the quality of generations and is more robust to certain issues, it is computationally intensive, particularly for large values of N. Specifically, Best-of-N sampling requires generating and evaluating N different candidate samples from a model for each inference step, significantly increasing the computational load and resource usage.

In view of these challenges, the present disclosure provides systems and methods for distillation of multi-sample preference sampling processes for sequence processing models. In particular, the present disclosure defines analytical expressions for multi-sample preference sampling distributions. Then, the proposed distillation training approach is framed as a distribution matching problem with respect to one of these analytical expressions. The distribution matching problem can be solved using various algorithms. For example, the student model can be finetuned via policy distillation techniques. The resulting student model is therefore able to provide the benefits of the multi-sample preference sampling process, including its robustness and ability to align with human preferences, while significantly reducing the computational overhead at inference time. In particular, the trained student model can produce high-quality text using only a single generation step, thereby offering a more efficient and scalable solution.

Another aspect of the present disclosure is directed to an iterative distillation procedure that includes iteratively distilling the multi-sample preference sampling distribution with respect to a previous and iteratively updated version of the model. To provide one example, the analytical expression for the multi-sample preference sampling distribution can refer to a reference model that represents a baseline model on which the multi-sample preference sampling process is performed. According to an aspect of the present disclosure, this reference model can be iteratively updated while the distillation training process is iteratively performed. For example, at each training iteration, the reference model can be set equal to the current version of the student model or a moving average of the student model parameters. This iterative technique enables the distillation approach to be applied with a small value of N, which has the advantages of a stable and sample-efficient distillation, and it does not require specifying a desired (large) N upfront.

The systems and methods of the present disclosure provide a number of technical effects and benefits. As one example technical effect, as compared to performing a multi-sample preference sampling process, the proposed techniques significantly improve the computational efficiency of sequence processing models (e.g., LLMs) during inference. In particular, this technical effect is achieved by distilling the complex multi-sample preference sampling distribution into a more streamlined student sequence processing model. By requiring only a single generation step at inference time, as opposed to the computationally intensive process of explicitly generating and a scoring multiple samples, the present disclosure reduces the demand on processing power and memory resources. This reduction in computational overhead is particularly advantageous for deploying sequence processing models in real-world applications where computational resources are limited or costly (e.g., in an “on-device” setting).

In addition to computational efficiency, the present disclosure enhances the technical performance of sequence processing models. By employing a distilled student model that imitates the multi-sample preference sampling policy, the present disclosure enables the generation of outputs (e.g., text outputs) that are more closely aligned with human preferences. This improvement in performance and alignment is a result of the distillation process, which incorporates the robustness of the multi-sample preference sampling policy into the student model, thereby optimizing the student model's ability to process and generate sequences that meet predefined quality or preference criteria.

As another example, the techniques provided herein represent a technical solution to the technical problems associated with RLHF, specifically reward misspecification and reward hacking by LLMs. By distilling the multi-sample preference sampling policy into the student model (e.g., as an alignment alternative to performing RLHF), the present disclosure obviates these issues, offering a stable and sample-efficient method for model training. This technical solution improves the reliability and functionality of the sequence processing model, ensuring that the model's outputs are consistent with the intended training objectives and are not the result of exploitative behavior by the model.

As yet another example, the present disclosure represents the contribution to the field of advanced machine learning techniques. Specifically, the present disclosure provides an explicit analytical expression for multi-sample preference sampling distributions, a novel technical contribution that facilitates the fine-tuning of sequence processing models via distribution matching (e.g., via policy distillation). This technical advancement in the field of machine learning not only provides a new tool for the development of generative models but also contributes to the broader understanding of how to effectively align sequence processing models with complex preference distributions.

### Introduction to Multi-Sample Preference Sampling

When sampling from generative models, one group of approaches do not simply take a single sample, but instead use a multi-sample preference sampling process. One example of this is a Best-of-N approach where the decoding system that handles decoding from the generative model samples n candidates and then takes the best sample according to a specific metric, e.g. a learned reward from a reward model or from suffix scoring.

More formally, let x be an arbitrary context and π_{SFT} be a learned model that maps from context x to a distribution over possible generations y. In some cases, this learned model π_{SFT} can be referred to as a “reference model.” Let r(x, y) be a function that assigns a real score to a context x and a generation y.

For any x, a Best-of-N sample is then given by:

$${y}_{BoN} = {argmax}_{y ∈ \{ {y}_{i} ∼ {π}_{SFT} ( y \vert x ) \vert i = 1 , 2 , … , n \}} r ( y ) \qquad ( 1 )$$

This approach is straight-forward and it often works well empirically, i.e. it often generates better samples than the underlying models. A key drawback of this approach is the computational cost: It requires n times more samples at inference time, which can often be prohibitive.

Therefore, it would be beneficial to obtain a model that has similar performance but where one only has to take a single sample. The naive approach of simply distilling Best-of-N samples into the model via supervised training loss often fails and does not achieve a similar performance. In contrast, the present disclosure provides a principled distillation-based approach based on matching a multi-sample preference sampling distribution that represents the multi-sample preference sampling process.

The discussion contained herein will focus on the case in which the multi-sample preference sampling process is the best-of-N sampling process. However, the approaches described herein can also be applied to other, different multi-sample preference sampling processes.

### The Best-of-N Sampling Distribution

This section provides an exact analytical distribution of Best-of-N sampling. For simplicity, the discussion drops the context x from all notation and assumes that the reward r(y) (and potential tie-breaking) induces a strict ordering on all generations y. For example, this can be achieved by performing tie-breaking on generations with the same reward based on an arbitrary strict ordering.

Theorem 1 For any generation y, let

$${p}_{<} ( y ) = {ℙ}_{{y}^{′} ∼ {π}_{SFT}} [ r ( {y}^{′} ) < r ( y ) ] \qquad ( 2 )$$

denote the probability that a random generation y′ from π_{SFT} is strictly worse than y and

$${p}_{\leq } ( y ) = {ℙ}_{{y}^{′} ∼ {π}_{SFT}} [ r ( {y}^{′} ) \leq r ( y ) ] . \qquad ( 3 )$$

the probability that y′ is not better than y.

Then, the probability that y is the output of best-of-N sampling is given by

$${π}_{BoN} ( y ) = {\underbrace{{π}_{SFT} ( y )}}_{( a )} \times {\underbrace{{{p}_{\leq } ( y )}^{n - 1}}}_{( b )} \times {\underbrace{{\sum }_{i = 1}^{n} {[ \frac{{p}_{<} ( y )}{{p}_{\leq } ( y )} ]}^{i - 1}}}_{( c )} . \qquad ( 4 )$$

Interpretation. Theorem 1 provides an intuitive explanation on the behavior of Best-of-N sampling: Best-of-N sampling essentially reweighs the original sampling distribution π_{SFT}, i.e., term (a), by the two multiplicative terms (b) and (c).

The term (b) corresponds to a penalty exponential in n based on the fraction of generations that are worse or equal to the considered generation y. Intuitively, this ensures that the decoding system samples less and less from bad generations.

The term (c) is an additional correction factor due to the potential of collisions in Best-of-N sampling. Importantly, it is at most linear in n as it is always bounded within [1, n] since we have

$$1 \leq 1 + {\sum }_{i = 2}^{n} {[ \frac{{p}_{<} ( y )}{{p}_{\leq } ( y )} ]}^{i - 1} = {\sum }_{i = 1}^{n} {[ \frac{{p}_{<} ( y )}{{p}_{\leq } ( y )} ]}^{i - 1} \leq {\sum }_{i = 1}^{n} 1 \leq n \qquad ( 5 )$$

The correction term (c) achieves its minimum at 1 for the worst generation y₋ since we have p_{<}(y₋)=0 by definition. This is not surprising, as we need to sample y₋ exactly n times in a row and which corresponds to π_{BoN}(y₋)=π_{SFT}(y₋)ⁿ (note that p_{<}(y₋)=π_{SFT}(y₋)). In contrast, if the likelihood of individual generations y are low and such generations are good, then p_{<}(y) is almost p_{≤}(y)=0 and the term (c) is close to n. Intuitively, this corresponds to the case where sampling a generation y multiple times is unlikely. For example, for the best generation y₊, we have that π_{BoN}(y₊)→nπ_{SFT}(y₊) as π_{SFT}(y₊)→0. This is not surprising, as there are n slots where y₊ can be sampled.

Proof. Consider n random generations y₁, y₂, yₙ from π_{SFT} and an arbitrary generation y. Let Aᵢ(y) denote the event that y is the best sample (i.e. r(y)≥r(yᵢ) for all i) and that i is the lowest index for which yᵢ=y. It is trivial to see that the events {Aᵢ(y)}_{i=1,2, . . . ,n} are disjoint and that their union corresponds to y being selected by Best-of-N sampling.

The event Aᵢ(y) occurs if and only if three conditions are met: (a) r(yⱼ)<r(y) for all j<i, (b) yᵢ=y, and (c) r(yⱼ)<r(y) for all j<i. This allows the likelihood of the event Aᵢ(y) to be derived:

$$\begin{matrix}ℙ [ {A}_{i} ( y ) ] = ( {\prod }_{j = 1}^{i - 1} ℙ [ r ( {y}_{j} ) < r ( y ) ] ) {π}_{SFT} ( y ) ( {\prod }_{j = i + 1}^{n} ℙ [ r ( {y}_{j} ) \leq r ( y ) ] ) \\ = {{p}_{<} ( y )}^{i - 1} \times {π}_{SFT} ( y ) \times {{p}_{\leq } ( y )}^{n - i - 1}\end{matrix} \qquad \begin{matrix}( 6 ) \\ ( 7 )\end{matrix}$$

The likelihood of that Best-of-N sampling selects the generation y is then given by

$$\begin{matrix}{π}_{BoN} ( y ) = {\sum }_{i = 1}^{n} ℙ [ {A}_{i} ( y ) ] \\ = {\sum }_{i = 1}^{n} [ {{p}_{<} ( y )}^{i - 1} \times {π}_{SFT} ( y ) \times {{p}_{\leq } ( y )}^{n - i} ] \\ = {π}_{SFT} ( y ) \times {\sum }_{i = 1}^{n} [ {{p}_{<} ( y )}^{i - 1} \times {{p}_{\leq } ( y )}^{n - i} ] \\ = {π}_{SFT} ( y ) \times {{p}_{\leq } ( y )}^{n - 1} \times {\sum }_{i = 1}^{n} {[ \frac{{p}_{<} ( y )}{{p}_{\leq } ( y )} ]}^{i - 1}\end{matrix} \qquad \begin{matrix}\begin{matrix}\begin{matrix}( 8 ) \\ ( 9 )\end{matrix} \\ ( 10 )\end{matrix} \\ ( 11 )\end{matrix}$$

Bounds. This provides also a bound on π_{BoN}(y).

$${π}_{SFT} ( y ) \times {{p}_{\leq } ( y )}^{n - 1} \leq {π}_{BoN} ( y ) \leq n \times {π}_{SFT} ( y ) \times {{p}_{\leq } ( y )}^{n - 1} \qquad ( 12 )$$

Alternatively, it can easily be shown that

$${π}_{BoN} ( y ) \geq n \times {π}_{SFT} ( y ) \times {{p}_{<} ( y )}^{n - 1} \qquad ( 13 )$$

Thus, Equation (4) can be referred to as the best-of-N sampling distribution. As represented in Equation (4), the best-of-N sampling distribution comprises a reference sampling distribution associated with the reference sequence processing model times a reweighting term times a correction factor. Specifically, the reweighting term in Equation (4) evaluates a reward quantile for the token sequence.

Equation (4) can also be generalized to obtain a more general analytic expression for a multi-sample preference sampling distribution. For example, the multi-sample preference sampling distribution can comprise the reference sampling distribution associated with the reference sequence processing model times a generalized reweighting term, wherein the generalized reweighting term evaluates or encodes some preference value for an input token sequence that is based on a generalized preference model. In particular, while the reweighting term in Equation (4) is a function of a reward model, a more generalized reweighting term may be a function of a more generalized preference model, where said preference model applies some criteria (e.g., neural, heuristic, or otherwise) for generating a preference score (or other preference representation such as rankings) for an input sample.

### Discussion of Connections to RLHF

In the standard Reinforcement Learning from Human Feedback (RLHF) setting, one often aims to optimize a linear combination of the expected reward and a KL divergence between

$${π}_{RL} = arg {max}_{π} {𝔼}_{π} [ {r}_{RL} ( y ) ] - β K L ( π \vert \vert {π}_{SFT} ) \qquad ( 14 )$$

It is simple to show that this is equivalent to finding the optimal policy

$${π}_{RL} ( y ) ∝ {π}_{SFT} ( y ) exp ( \frac{1}{β} {r}_{RL} ( y ) ) \qquad ( 15 )$$

which is known up to the normalizing constant.

From Theorem 1, it can be seen that the Best-of-N sampling distribution is the solution to the standard RLHF problem with what can be referred to as the Best-of-N Distillation reward:

$${r}_{BOND} ( y ) = {\underbrace{log {p}_{\leq } ( y )}}_{( A )} + {\underbrace{\frac{1}{n - 1} log {\sum }_{i = 1}^{n} {[ \frac{{p}_{<} ( y )}{{p}_{\leq } ( y )} ]}^{i - 1}}}_{( B )} \qquad ( 16 )$$

and the hyperparameter

$${β}_{BOND} = \frac{1}{n - 1} .$$

The term (B) corresponds to the correction factor in Theorem 1, which is bounded in

$$[ 0 , \frac{log n}{n - 1} ]$$

for all generations y. Ignoring this correction factor, two interesting insights into Best-of-N sampling can be obtained:

1. Best-of-N sampling corresponds to the solution of a KL regularized Markov Decision Process where the choice of n determines the level of KL regularization. Under some assumptions, the entropy of π_{BoN} is essentially given by n.

2. Best-of-N sampling corresponds to optimizing the expected log likelihood of the reward of the generation being better than the reward of a random sample from the anchor distribution. Interestingly, due to the concavity of the logarithm, this more strongly encourages the model to avoid bad generations than it encourages the model to generate good generations. In addition, r_{BOND}(y) is invariant to monotone transformations of the learned reward r(·), since it depends only on the rank among the generations. Both of these features may make the Best-of-N Distillation reward r_{BOND}(y) more robust to reward hacking compared to the learned rewards often used in RLHF.

### Discussion of Connections to DPL

Direct preference learning (DPL) methods such as DPO and RSO use the analytical formula of the optimal policy for the KL-regularized objective. This is described below, still omitting the context on purpose:

$${π}^{*} ( y ) = \frac{1}{Z} {π}_{SFT} ( y ) exp ( \frac{r ( y )}{β} ) . \qquad ( 17 )$$

One can show that:

$$r ( y ) = β log \frac{{π}^{*} ( y )}{{π}_{SFT} ( y )} + βlog Z , \qquad ( 18 )$$

which can then be plugged in the Bradley-Terry formula to get that the probability of a generation being preferred to another is:

$$P ( {y}_{+} ≻ {y}_{-} ) = {( 1 + exp ( β log \frac{{π}^{*} ( {y}_{-} )}{{π}_{SFT} ( {y}_{-} )} - β log \frac{{π}^{*} ( {y}_{+} )}{{π}_{SFT} ( {y}_{+} )} ) )}^{- 1} . \qquad ( 19 )$$

In the case of interest, there are typically no preference pairs (y₊, y₋), but there is access to an analytical form for the optimal policy π* (e.g., Equation (4)), which can be used here, along with β_{BOND}. Supposing the correction factors cancel out, we get:

$$P ( {y}_{+} ≻ {y}_{-} ) = {( 1 + exp ( log {p}_{\leq } ( {y}_{-} ) - log {p}_{\leq } ( {y}_{+} ) ) )}^{- 1} . \qquad ( 20 )$$

Framing this as maximum likelihood estimation, the equivalent of the DPO loss for distribution matching can be obtained:

$${ℒ}_{DPO} ( {p}_{\leq } ) = - {𝔼}_{( {y}_{+ λ} {y}_{-} ) ∼ 𝒟} [ log σ ( log {p}_{\leq } ( {y}_{-} ) - log {p}_{\leq } ( {y}_{+} ) ) ] , \qquad ( 21 )$$

To make use of this loss, the dataset of preferences [symbol] should be defined, which requires careful examination. Suppose that there is access to a dataset of arbitrary generations and that it is desired to form pairs of preferred versus non-preferred generations. The only requisite is that reference pairs (y₊, y₋) should have a preference label sampled from P(y₊>y₋). Thus, if there is access to p_{≤}or to an approximation, a dataset of preference pairs can be constructed and then DPO can be run on such dataset.

An equivalent approach can be derived that directly learns a policy π instead of p_{≤}. With an identically constructed dataset we have the corresponding loss:

$${ℒ}_{DPO} ( \text{} π ) = \text{} - {𝔼}_{( {y}_{+} , {y}_{-} ) ∼ 𝒟} [ \text{} log σ ( \frac{1}{n - 1} log \frac{π ( {y}_{-} )}{{π}_{SFT} ( {y}_{-} )} - \frac{1}{n - 1} log \frac{π ( {y}_{+} )}{{π}_{S F T} ( {y}_{+} )} ) ] . \qquad ( 22 )$$

### Example Methods for Estimating the Reward

A key difficulty in estimating the BOND Reward and π_{BoN} is that we need to be able to estimate:

$${p}_{<} ( y ) = {ℙ}_{{y}^{′} ∼ {π}_{SFT}} [ r ( {y}^{′} ) < r ( y ) ] . \qquad ( 23 )$$

Two example approaches are described in this section: Monte Carlo sampling and learning a quantile model.

### Monte Carlo Sampling

This approach consists, for a given generation y, in sampling k generations from π_{SFT} and obtaining the following empirical estimate:

$${\hat{p}}_{<} ( y ) = \frac{1}{k} {\sum }_{i = 1}^{k} \{ r ( {y}_{i} ) < r ( y ) \} . \qquad ( 24 )$$

There is a relationship between this estimate and the ranking of the generation y among all generations. Indeed, if R(y, {yᵢ}ᵢ) is the corresponding empirical ranking, it can be shown that:

$${\hat{p}}_{<} ( y ) = 1 - \frac{R ( y , {\{ {y}_{i} \}}_{i} )}{k} . \qquad ( 25 )$$

This link is interesting as we might want learn an estimator of p_{<}(y), for instance learning it offline and using it online instead of Monte Carlo samples. Instead of regressing \hat{p}_{<}(y) directly, we can do multi-class classification and estimate the ranking of y, which might prove easier to learn as it is discrete (we can also penalize ranking errors as we see fit). The limitation is that it requires k to be fixed, which is not the case for the regressive approach.

### Learned Reward Quantile Model

Monte-Carlo sampling requires creating a large number of generations for each context. Another approach is create a context and generation-dependent learned estimator [symbol] (y) for p_{<}(y). It can be seen that p_{<}(y) corresponds to the parameter of a Binomial random variable Z where Z= [symbol] {r(yᵢ)<=r(y)} for yᵢ˜π_{SFT}. The parameters can be learned via maximum likelihood estimation and the following cross-entropy loss:

$$L ( y ) = - {𝔼}_{{y}^{′} ∼ {π}_{SFT}} [ log ( y ) {\{ r ( {y}^{′} ) \leq r ( y ) \}}_{} + log ( 1 - ( y ) ) {\{ r ( {y}^{′} ) > r ( y ) \}}_{} ] \qquad ( 26 )$$

While minimizing the above loss yields an unbiased estimate of the quantiles, it may require many samples to obtain accurate estimates. To cope with this, alternative learned quantile models can be used, e.g. enforcing the ordering of the quantiles or assuming a pre-specified, e.g. Gaussian, rewards distributions.

### Example Distillation Approaches

A key goal of this section is to learn a distribution/policy π t that approximates the BoN distribution, i.e., a goal is to have

$$π \approx {π}_{BoN} . \qquad ( 27 )$$

This is a distribution matching problem and various approaches can be applied to solve the problem.

### Supervised Finetuning/Behavioral Cloning of π_{BoN}

BOND-BC: One possible approach is to minimize the forward KL between the BoN distribution and the student policy π, i.e., minimize the loss

$${L}_{BC} = KL ( {π}_{BoN} \vert \vert π ) = {E}_{y ∼ {π}_{BoN}} [ log {π}_{BoN} ( y ) - log π ( y ) ] \qquad ( 28 )$$

This corresponds to a supervised finetuning loss which can be approximated (and minimized) by using samples from the BoN distribution. This can also be seen as Behavioral Cloning of π_{BoN}. There are two drawbacks to this approach: First, this approach encourages high recall of the BoN distribution (as it enforces that all samples from π_{BoN} are likely under the policy). Hence, it may lead to an overdispersed model. Second, it requires sampling from π_{BoN} which is n times more expensive than sampling, e.g., from π_{SFT} or π. Indeed, given n samples from π_{SFT}, it uses only the BoN sample and does not learn from the other n−1 ones.

BOND-BC-IS: To address the second concern, another example approach can use importance sampling to learn from arbitrary samples from π_{SFT}, via the loss:

$${L}_{BC - IS} = KL ( {π}_{BoN} \vert \vert π ) = {E}_{y ∼ {π}_{SFT}} [ \frac{{π}_{BoN} ( y )}{{π}_{SFT} ( y )} ( log {π}_{BoN} ( y ) - log π ( y ) ) ] \qquad ( 29 )$$

### Reinforcement Learning

Another example approach is to minimize the forward KL between the student policy π t and the BoN distribution, i.e., minimizing the loss:

$${L}_{RL} = KL ( π \vert \vert {π}_{BoN} ) = {E}_{y ∼ π} [ log π ( y ) - log {π}_{BoN} ( y ) ] \qquad ( 30 )$$

As shown next, this has a close connection with the RL approaches that aim at maximizing the RL objective of Equation (14).

Notably, unlike L_{BC}, the above loss does not require sampling from BoN, but from the policy π. Alternatively, importance sampling can be used to learn from arbitrary samples from π_{SFT}. Both of these approaches are outlined next.

BOND-PG: One example approach can minimize L_{RL} via gradient descent on batches of samples from π. The exact gradient can be derived as:

$$\begin{matrix}{∇}_{π} KL ( π \vert \vert {π}_{BoN} ) = {∇}_{π} {E}_{y ∼ π} [ log π ( y ) - log {π}_{BoN} ( y ) ] \\ = {∇}_{π} {\sum }_{y} π ( y ) ( log π ( y ) - log {π}_{BoN} ( y ) ) \\ = {\sum }_{y} {∇}_{π} π ( y ) ( log π ( y ) - log {π}_{BoN} ( y ) ) + π ( y ) - {∇}_{π} log π ( y ) \\ = {\sum }_{y} π ( y ) {∇}_{π} log π ( y ) ( log π ( y ) - log {π}_{BoN} ( y ) ) - π ( y ) {∇}_{π} log π ( y ) \\ = {E}_{y ∼ π} [ {∇}_{π} log π ( y ) ( log π ( y ) - log {π}_{BoN} ( y ) ) - {∇}_{π} log π ( y ) ] \\ = {E}_{y ∼ π} [ {∇}_{π} log π ( y ) ( log π ( y ) - log {π}_{BoN} ( y ) ) ]\end{matrix}$$

Above, the derivation has used the rule ∇_{y} log π(y)=π(y)∇_{y} log π(y) and the fact that [symbol] _{y˜π}∇_{y} log π(y)=0.

Equivalence with Policy Gradient RL. As anticipated, one can verify that descending the above gradient is equivalent—up to a constant scaling—to running the RL policy gradient REINFORCE algorithm on the RL objective of Equation (14) with r_{RL}=r_{BOND} and β=β_{BOND}. Indeed, the expression for π_{BoN} can be used to break down the above gradient into:

$${E}_{y ∼ π} [ {∇}_{π} log π ( y ) ( log π ( y ) - log {π}_{B o N} ( y ) ) ] = {E}_{y ∼ π} [ \text{} {∇}_{π} log π ( y ) ( log π ( y ) - log {π}_{SFT} ( y ) - ( n - 1 ) log {p}_{\leq } ( y ) - log {\sum }_{i = 1}^{n} {[ \frac{{p}_{<} ( y )}{{p}_{\leq } ( y )} ]}^{i - 1} ) ] = {E}_{y ∼ π} [ {∇}_{π} log π ( y ) ( log π ( y ) - log {π}_{SFT} ( y ) - \frac{{r}_{BOND} ( y )}{n - 1} ) ] = \text{} - ( n - 1 ) {\underbrace{{E}_{y ∼ π} [ {∇}_{π} log π ( y ) ( {r}_{BOND} ( y ) - {β}_{BOND} ( log π ( y ) - log {π}_{SFT} ( y ) ) ) ]}}_{gradientusedbyREINFORCE} .$$

BOND-PG-IS: Also in this case, some example implementations can use importance sampling to learn from arbitrary samples from π_{SFT} by utilizing unbiased estimates of the BOND-PG gradient:

$${E}_{y ∼ {π}_{SFT}} [ \frac{π ( y )}{{π}_{SFT} ( y )} {∇}_{π} log π ( y ) ( log π ( y ) - log {π}_{BoN} ( y ) ) ] . \qquad ( 31 )$$

### Offline Distribution Matching Regression

Additional example implementations employ the following approach: 1) generate an offline dataset using π_{SFT}, 2) estimate the probability function \hat{P}(x, ·)= [symbol] _{y′˜π}_{_{SFT}}[r(x, ·)≥r(x, y′)] from such a dataset, and 3) compute n minimizing the L2-regression loss:

$${L}_{BoN} ( π , x , y ) = {( log π ( x , y ) - log {π}_{BoN} ( x , y ) )}^{2} = {( log π ( x , y ) - log {π}_{SFT} ( x , y ) - log n - ( n - 1 ) \cdot log \hat{P} ( x , y ) )}^{2}$$

An example of this overall approach is summarized in Algorithm 1:

Algorithm 1: BoN Distribution matching - offline regression:

```
Inputs: Prompts [symbol]   , π_{SFT}, n, M.
Step 1: Use π_{SFT} to generate offline dataset [symbol]   = {x, [symbol]   :
  For each prompt x~ [symbol]   , sample M responses using π_{SFT}.
Step 2: Estimate probability function \hat{P}(x,·) = [symbol]   _{y′~π}_{_{SFT}} [r(x,·) ≥ r(x, y′)] using the above
dataset.
Step 3: Compute π_{BoN} = argmin_{π} [symbol]   L_{BoN}(π, x, y) via finetuning:
Initialize π₀ = π_{SFT}
for t = 1, ... , T do
  sample batch [symbol]   _{batch} ⊆ [symbol]
  πₜ = πₜ₋₁ − η [symbol]   ∇_{π}L_{BoN}(π, x, y)
end for
Return: π_{T}
```

### Refurbishing Pairwise Offline Approaches for Distribution Matching

### Option 1: Natural Approach:

Another option is to use pairwise offline methods (e.g. DPO, IPO, LiRioPe, SLIC-HF, RSO, etc) and treat best responses as preferred responses, while other responses are negative responses. Some approaches can take advantage of extra pairwise feedback (i.e. that the second best response is better than the second to last response). Note that the optimal policy for the described approach is not π_{BoN}, so this approach can be treated as a natural baseline instead of a solution to the problem at hand.

### Option 2: Principled Approach:

As discussed above, it is possible to derive a simple form of DPO (resp. RSO/IPO) that admits π_{BoN} as optimal policy. The approach requires an arbitrary dataset of prompts with several generations, as well as an approximation of p_{≤} to establish preference pairs. Once preference pairs are formed, the offline DPO algorithm can be used for learning.

### Example Settings

When considering example distillation algorithms, there are three main drivers of computational cost:

Offline samples from π_{SFT}: This corresponds to sampling from the fixed policy π_{SFT} for a certain set of prompts. This can be done offline (i.e., before the main algorithm), making it suitable for parallelisation and caching.

Online samples from π (or π_{SFT}): This refers to sampling that happens during the actual algorithm in between learning steps. This usually cannot be cached and leads to increased complexity of the implementation.

Forward backward passes on it: This corresponds to the learning step where a gradient update is performed on the current policy π t via a forward and backward pass on a fixed set of samples.

Two different settings are considered below that have different practical implications.

Self-distillation. In this setting, π_{SFT} and π refer to the same model architecture and size and the goal is to simply amortize the cost of Best-of-N sampling. In this setting, some example implementations can set the initial policy to exactly π_{SFT}. In this setting, offline and online sampling has largely the same cost. The advantage of offline samples rather than online samples relates largely to being able to reuse the generated samples and to a simpler finetuning infrastructure.

Large-to-small distillation. In this setting, the objective is to distill Best-of-N sampling of a larger model directly into a small model. Sampling from π_{SFT} is expensive and requires a larger accelerator slice than sampling for It. This makes offline sampling and caching attractive. Some example implementations can further compute sequence likelihoods π_{SFT}(y) offline but not the logits (due to their sizes). Online sampling from π and forward/backward passes through π are relatively cheap. Due to the size, the initial policy π is different than π_{SFT}.

### Example Distillation Algorithms

This section presents specific distillation algorithms following the approaches developed in the previous sections.

### J-BOND: Jeffrey's Divergence BOND

The idea behind J-BOND is to minimize the Jeffrey's divergence between the policy and the BoN distribution. For a mixing parameter β∈(0, 1), this is defined as:

$$Jeffrey ’ {s}_{β} ( π , {π}_{BoN} ) := β \cdot KL ( π \vert \vert {π}_{BoN} ) + ( 1 - β ) \cdot KL ( {π}_{BoN} \vert \vert π ) ,$$

i.e. a linear combination between the forward and backward KL divergences. This allows J-BOND to effectively interpolate (for a given β) between the mode-covering behavior of BOND-BC (β=0) and the mode-seeking behavior of BOND-PG (β=1), ideally retaining the best from each of these two extrema.

A detailed example implementation of J-BOND is provided in Algorithm 2 (e.g., using MC quantile estimates) and Algorithm 3 (e.g., using Learned Quantiles). A common denominator is the Jeffrey's divergence loss which can be computed as a linear combination of the backward and forward KL losses of BOND-PG and BOND-BC, respectively.

```
Algorithm 2: Jeffrey's div. BOND with MC quantiles (J-BOND-MC):
Inputs: n ∈ [symbol] , dataset [symbol] , reward r(·), π_{SFT}, M_{anchor}, M_{policy} ∈ [symbol] , β ∈[0,1].
Initialize π₀ = π_{SFT}.
for t = 0, . . . , T do
  Sample batch [symbol] ₜ ⊆ [symbol]
  For each prompt x ∈ [symbol] ₜ generate: [symbol] ₐ^{x} = {M_{anchor} samples from π_{SFT}}, [symbol]
  _{b}^{x} = {n samples from π_{SFT}}, [symbol] _{c}^{x} = {M_{policy} samples from πₜ}.
  */ MC quantile estimates */
  For each y ∈ [symbol] _{c}^{x} compute MC quantile estimates \hat{p}_{≤} (x, y) using [symbol] ₐ^{x}
    ${\hat{p}}_{\leq } ( x , y ) = \frac{1}{\vert {𝒟}_{a}^{x} \vert} {\sum }_{y ∈ {𝒟}_{a}^{x}} 𝕀 \{ r ( {y}_{i} ) \leq r ( y ) \}$
  */ Backward KL loss */
  Compute advantage: A(x, y) = logπₜ (x, y) − log\hat{π}_{BoN} (x, y),
    where logπ_{BoN}(x, y) = logπ_{SFT}(x, y) + (n − 1) · log\hat{p}_{≤}(x, y) + logn.
  Compute baseline: B(x, y) = [symbol]  A(x′, y′)
  Compute loss:
    L_{RL} (πₜ) = [symbol]  [∇_{π}_{ₜ}logπₜ (x, y) · stop_grad(A(x, y) − B(x, y))],
  */ Forward KL loss */
  Extract BoN samples from [symbol] _{b}^{x}: y_{BoN}^{x} = argma [symbol]  r(y).
Compute loss:
        L_{BC}(πₜ = [symbol]  [− logπₜ(y_{BoN}^{x})].
*/ Jeffrey's divergence loss */
  Compute overall loss:
    L(πₜ) = β · L_{RL}(πₜ) + (1 − β) · L_{BC}(πₜ)
Update policy: πₜ₊₁ = πₜ − η∇πₜL(πₜ)
end for
Return: π_{T}
```

```
Algorithm 3: Jeffrey's div. BOND with Learned Quantiles (J-BOND-LQ):
Inputs: n ∈ [symbol] , dataset [symbol] , reward r(·), π_{SFT}, β ∈ [0,1].
Initialize π₀ = π_{SFT}, π₀^{value}(·) = π_{SFT}.
for t = 0, . . . , T do
  Sample batch [symbol] t ⊆ [symbol]
  For each prompt x ∈ [symbol] ₜ generate: [symbol] ₐ^{x} = {1samplefromπ_{SFT}}, [symbol]
  _{b}^{x} = {nsamplesfromπ_{SFT}}, D_{c}^{x} = {1samplefromπₜ}.
  */ Predict learned quantiles
  For each y ∈ [symbol]  _{c}^{x},
    $V ( x , y ) = σ ( \frac{1}{\# - of - tokens} \sum logits ( {π}_{t}^{v a l u e} ( x , {y}_{: - 1} ) ) )$
    \hat{p}_{≤}(x, y) = V(x, y)
  */ Backward KL loss */
  Compute advantage: A(x, y) = logπₜ(x, y) − log\hat{π}_{BoN} (x, y),
    where logπ_{BoN} (x, y) = logπ_{SFT}(x, y) + (n − 1) · log\hat{p}_{≤} (x, y) + logn.
  Compute baseline: B(x, y) = [symbol]  A(x′, y′)
  Compute loss:
    L_{RL} (πₜ) = [symbol] [∇_{π}_{ₜ}logπₜ (x, y) · stop_grad(A(x, y) − B(x, y))],
  */ Forward KL loss */
  Extract BoN samples from [symbol] _{b}^{x}: y_{BoN}^{x} = argma [symbol]  r (y).
  Compute loss:
      L_{BC}(πₜ) = [symbol]  [− logπₜ (y_{BoN}^{x})].
  */ Jeffrey's divergence loss */
  Compute overall policy loss:
      L(πₜ) = β · L_{RL}(πₜ) + (1 − β) · L_{BC}(πₜ).
  */ Value loss (binary cross-entropy) */
    L^{value} (πₜ^{value}) = − [symbol]  [log V(y) ·II_{{r(y′)≤r(y)}} +
        log(1 −V(y)) ·II_{{r(y′)≤r(y)}}].
  Update policy: πₜ₊₁ = πₜ − η∇πₜL(πₜt)
  Update value: πₜ₊₁^{value} = πₜ^{value} − η∇_{π}_{ₜ}_{^{value}}L^{value} (πₜ^{value})
end for
Return: π_{T}
```

### Iterative Optimization Approaches

In practice, choosing parameter π may be difficult for the following three main reasons: 1) Similar to RLHF, n plays the role of regularization: a large n improves downstream performance, but a too large n will eventually cause reward over optimization, 2) estimating KL(π_{BoN}∥π) requires sampling from π_{BoN} which can be prohibitive for large values of n, 3) the larger the n the more estimates of π_{BoN} are sensible to errors in the estimated quantiles (since πBoN(y)∝p_{≤}(y)ⁿ⁻¹).

To cope with the above, some example implementations of the present disclosure can perform an iterative BOND approach. This approach leverages the recognition that operating best-of-n sampling from a best-of-n distribution coincides with doing best-of-n² sampling from the original distribution. Therefore, some example implementations can fix a small n (e.g., n=2) and apply the proposed distillation approaches in a iterative fashion to the currently training policy.

More formally, some example implementations can start applying BOND to the original anchor policy π_{anchor}=π_{SFT} policy and, after a pre-specified (update_anchor_every∈ [symbol] ) number of steps, the optimization approach can update π_{anchor} to be the current training policy π t. Alternatively, instead of performing hard anchor updates, some example implementations can update the anchor weights with an exponential moving average (EMA) defined by parameter ema∈[0, 1]:

$$weights ( {π}_{anchor} ) = e m a \cdot weights ( {π}_{t} ) + ( 1 - e m a ) \cdot weights ( {π}_{anchor} ) .$$

An example of this iterative approach is summarized in Algorithm 4.

Algorithm 4: Iterative BOND (meta algorithm):

```
Inputs: π_{SFT}, update_anchor_every ∈ [symbol]   , ema ∈ [0,1].
Initialize π₀ = π_{SFT}
Initialize π_{anchor} = π_{SFT}
for t = 1, ... , T do
  πₜ = BOND_learning_step(πₜ₋₁, π_{anchor})
  if t % update_anchor_every == 0 then
    weights(π_{anchor}) = ema · weights(πₜ) + (1 − ema) · weights(π_{anchor})
  end if
end for
Return: π_{T}
```

### Example Methods

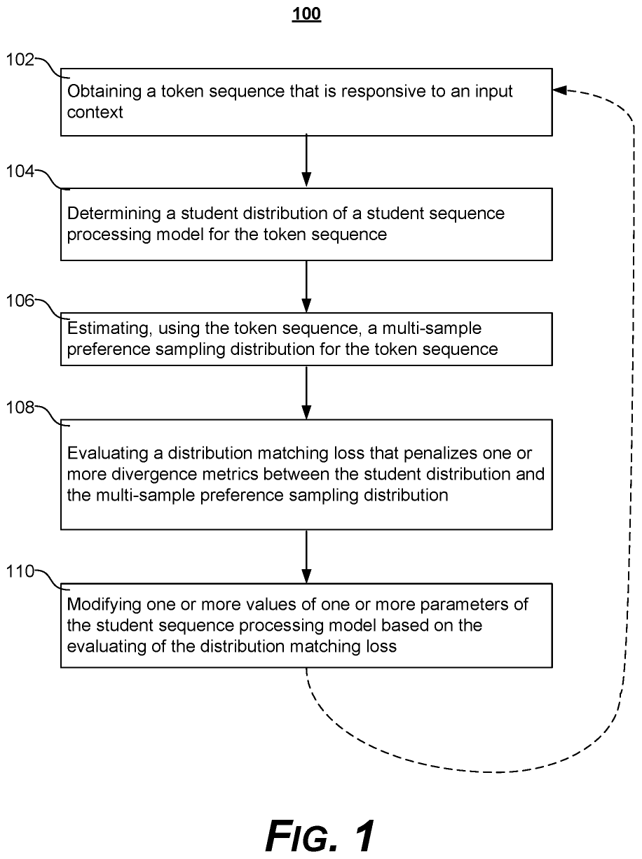

FIG. 1 illustrates a flowchart diagram of an example method 100 for distilling a multi-sample preference sampling distribution into a student sequence processing model, which is executed by a computing system comprising one or more computing devices.

The method begins at step 102, where the computing system obtains a token sequence that is responsive to an input context. For example, the token sequence can be sampled from the student sequence processing model, from the reference model, and/or from other sources (e.g., retrieved and replayed from a data store).

At step 104, the computing system determines a student distribution for the token sequence, which characterizes the likelihood that the student sequence processing model generates the token sequence given the input context.

Moving to step 106, the computing system estimates the multi-sample preference sampling distribution for the token sequence. This estimation characterizes the likelihood that the token sequence is returned by a multi-sample preference sampling process when applied to a reference sequence processing model given the input context.

In certain implementations, the multi-sample preference sampling process includes the generation of multiple candidate samples from the reference sequence processing model given the input context and the application of a preference model to select an output sample from these candidates. Specifically, in a best-of-N sampling process, each candidate sample is evaluated with a reward model to generate a reward score, and the sample with the highest score is selected as the output sample.

In some implementations, the multi-sample preference sampling distribution comprises a reference sampling distribution associated with the reference sequence processing model multiplied by a reweighting term, which evaluates a preference value for the token sequence based on the preference model. When the distribution is a best-of-N sampling distribution, it can include a correction factor along with the reweighting term, which evaluates a reward quantile for the token sequence.

In some implementations, estimating the multi-sample preference sampling distribution at 106 can include estimating the best-of-N sampling distribution by performing a Monte Carlo estimate of the reward quantile for the token sequence. This can include sampling a number of random sequences from the reference model and determining the reward quantile based on the number of random sequences for which the reward generated for the token sequence is greater than or equal to the reward generated for each random sequence.

In some implementations, estimating the multi-sample preference sampling distribution at 106 can include processing the token sequence with a machine-learned quantile estimation model, which may have been initialized from the reference sequence processing model and trained using binary cross-entropy loss on actual reward outcomes. Processing with the quantile estimation model can include determining a sigmoid of a token-length-normalized sum of logit values of the reference model for the token sequence.

At step 108, the computing system evaluates a distribution matching loss that penalizes one or more divergence metrics between the student distribution and the multi-sample preference sampling distribution. In some implementations, the divergence metrics used in the evaluation of the distribution matching loss can include F-divergences, backward KL divergence, or Jeffrey's divergence metrics.

Finally, at step 110, the computing system modifies one or more values of one or more parameters of the student sequence processing model based on the evaluation of the distribution matching loss. For example, depending on the implementation, optimizing the distribution matching loss can be carried out using a reinforcement learning algorithm, using an offline regression algorithm, and/or via other approaches.

In some implementations, the method may further involve initializing the student sequence processing model from the reference sequence processing model. In some implementations, the student sequence processing model may have a smaller number of parameters than the reference sequence processing model, allowing for more efficient computation.

Method 100, as depicted in FIG. 1, can be performed as an iterative process for distilling a multi-sample preference sampling distribution into a student sequence processing model. After completing the initial cycle of steps—from obtaining a token sequence responsive to an input context 102 to modifying the parameters of the student model based on the distribution matching loss 110—the method can begin anew.

This iterative nature allows for continuous refinement of the student model's alignment with the multi-sample preference sampling distribution. Each iteration builds upon the adjustments made in the previous cycle, potentially leading to a more accurate and efficient student model that reliably generates token sequences in line with human preferences and the reference model's output.

In some implementations, after completion of method 100, the student sequence processing model can be deployed. For example, the student sequence processing model can be used to generate completions or other outputs with increased computational efficiency, e.g., as compared to the multi-sample preference sampling process.

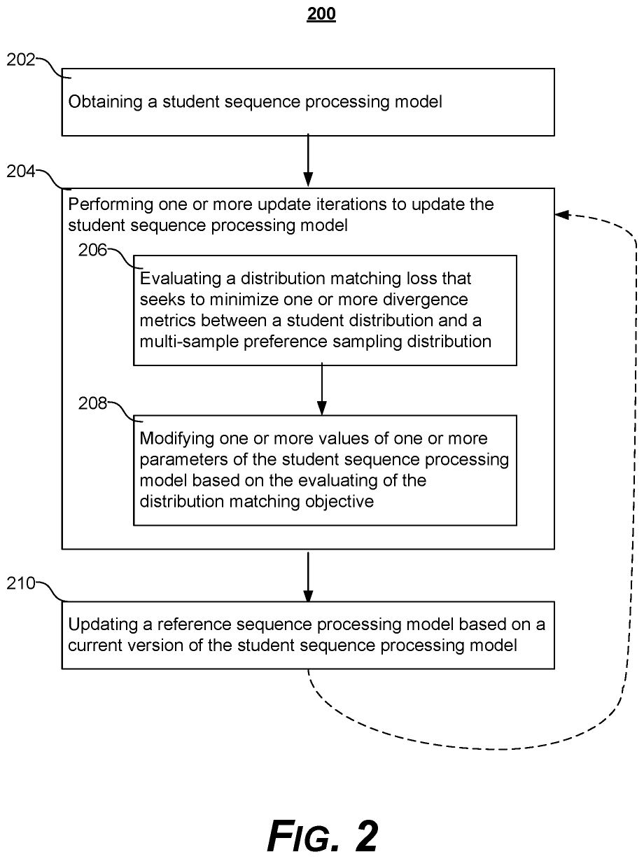

FIG. 2 presents a method 200 for refining a student sequence processing model through iterative updates and alignment with a reference sequence processing model. The method begins at step 202, where a student sequence processing model is obtained by a computing system.

At step 204, the computing system performs a series of update iterations to improve the student sequence processing model. Each update iteration includes two key steps:

Firstly, at step 206, the computing system evaluates a distribution matching loss for one or more token sequences that are generated in response to one or more context inputs. This loss quantifies the divergence between the student distribution (reflecting the student model's output) and a multi-sample preference sampling distribution (reflecting the output of a reference sequence processing model using a multi-sample preference sampling process). The goal of this evaluation is to minimize the divergence metrics between the two distributions, thereby aligning the student model more closely with the reference model's behavior.

Secondly, at step 208, based on the evaluation of the distribution matching loss, the computing system modifies the values of one or more parameters of the student sequence processing model. These modifications are aimed at optimizing the student model's performance and its alignment with the desired output distribution.

Finally, at step 210, the method includes updating the reference sequence processing model based on the current version of the student sequence processing model. This step ensures that the reference model stays relevant and reflects the improvements made to the student model during the iterative update process.

In some implementations, the update to the reference model is performed by directly setting it to the current version of the student model. In other implementations, the reference model is updated based on a moving average of the student model's parameter values, which can include an exponential moving average. These updates may occur periodically and result in continuous improvement and alignment of the student model with the multi-sample preference sampling process.

Method 200, as shown in FIG. 2, is designed to be an iterative process for updating a student sequence processing model using a distribution matching loss. Following the last step of updating the reference sequence processing model based on the current version of the student model 210, the method can loop back to the beginning to start another round of update iterations. This iterative approach ensures that each cycle of evaluation and modification (206 and 208) leverages the most recent advancements in the student model's parameters, thereby facilitating progressive improvement in the model's performance.

In some implementations, after completion of method 200, the student sequence processing model can be deployed. For example, the student sequence processing model can be used to generate completions or other outputs with increased computational efficiency, e.g., as compared to the multi-sample preference sampling process.

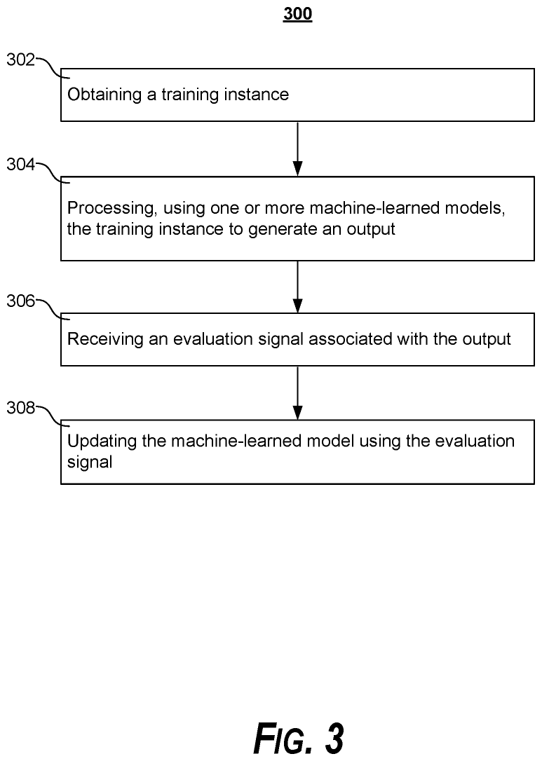

FIG. 3 depicts a flowchart of a method 300 for training one or more machine-learned models according to aspects of the present disclosure. For instance, an example machine-learned model can include a sequence processing model. In some cases, method 300 may be viewed as a method for pre-training a reference model.

One or more portion(s) of example method 300 can be implemented by a computing system that includes one or more computing devices such as, for example, computing systems described with reference to the other figures. Each respective portion of example method 300 can be performed by any (or any combination) of one or more computing devices. Moreover, one or more portion(s) of example method 300 can be implemented on the hardware components of the device(s) described herein, for example, to train one or more systems or models. FIG. 3 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 3 is described with reference to elements/terms described with respect to other systems and figures for exemplary illustrated purposes and is not meant to be limiting. One or more portions of example method 300 can be performed additionally, or alternatively, by other systems.

At 302, example method 300 can include obtaining a training instance. A set of training data can include a plurality of training instances divided between multiple datasets (e.g., a training dataset, a validation dataset, or testing dataset). A training instance can be labeled or unlabeled. Although referred to in example method 300 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 304, example method 300 can include processing, using one or more machine-learned models, the training instance to generate an output. The output can be directly obtained from the one or more machine-learned models or can be a downstream result of a chain of processing operations that includes an output of the one or more machine-learned models.

At 306, example method 300 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 308, example method 300 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 300 can include implementing a number of generalization techniques (e.g., weight decays, dropouts, etc.) to improve the generalization capability of the models being trained.

In some implementations, example method 300 can be implemented for training a machine-learned model from an initialized state to a fully trained state (e.g., when the model exhibits a desired performance profile, such as based on accuracy, precision, recall, etc.).

In some implementations, example method 300 can be implemented for particular stages of a training procedure. For instance, in some implementations, example method 300 can be implemented for pre-training a machine-learned model. Pre-training can include, for instance, large-scale training over potentially noisy data to achieve a broad base of performance levels across a variety of tasks/data types. In some implementations, example method 300 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

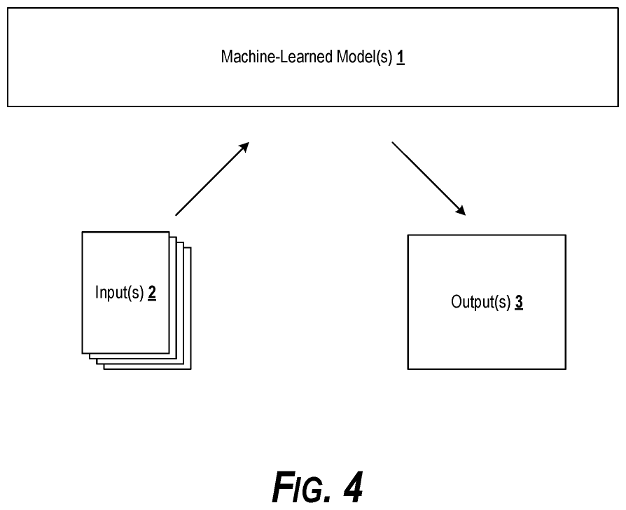

FIG. 4 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

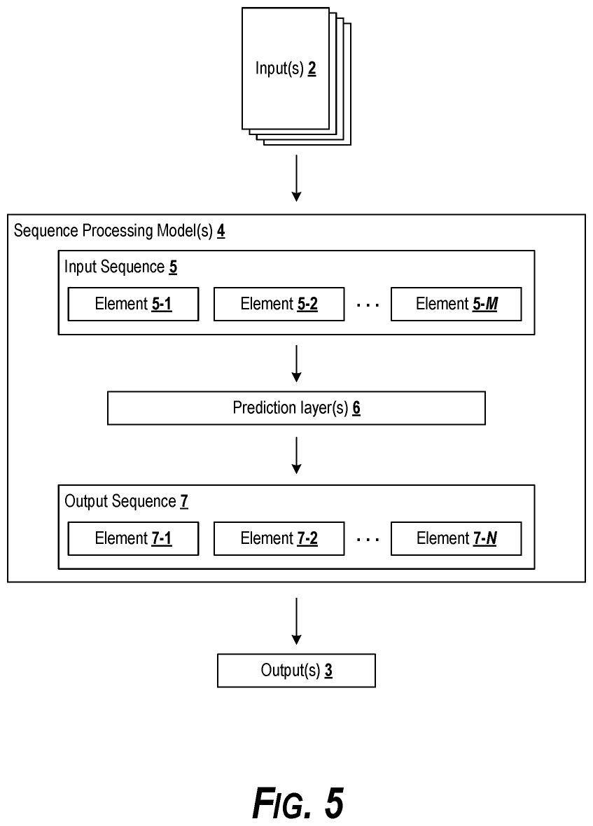

FIG. 5 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 5 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

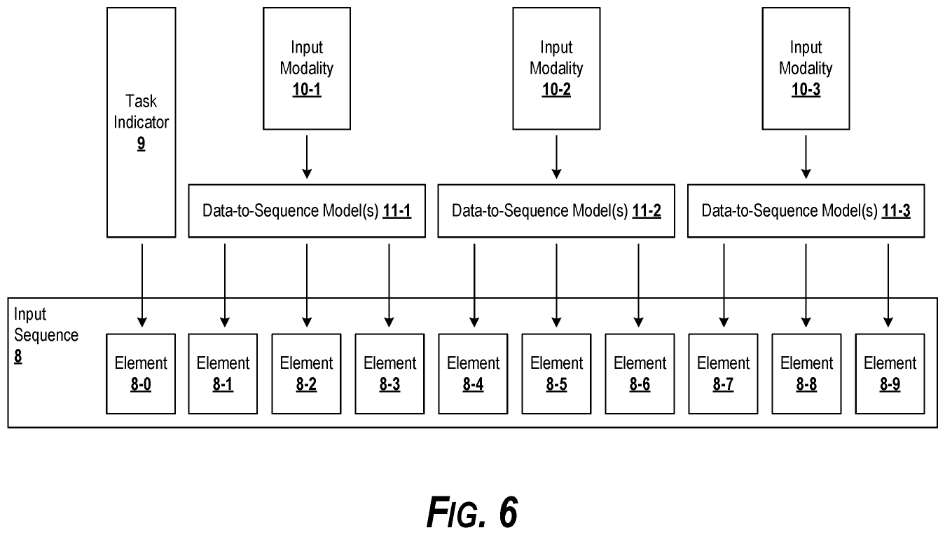

FIG. 6 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

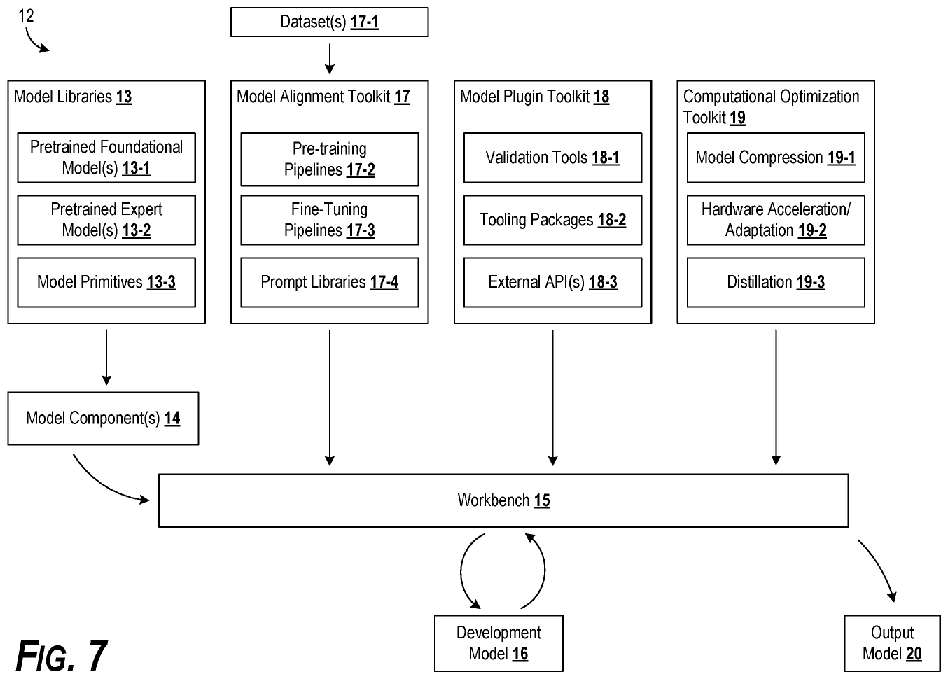

FIG. 7 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 300 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference. For example, the distillation tools 19-3 can perform the distillation techniques described herein. The distillation tools 19-3 can be embodied in computer systems, apparatus, and/or computer programs recorded on one or more computer storage devices, each configured to perform the described distillation techniques.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

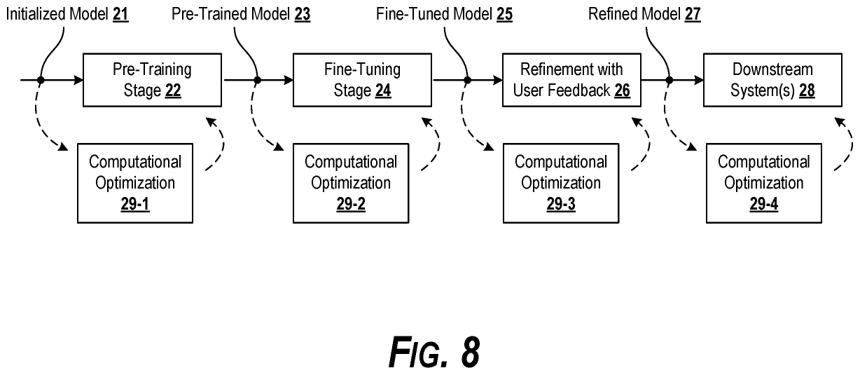

FIG. 8 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 8 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

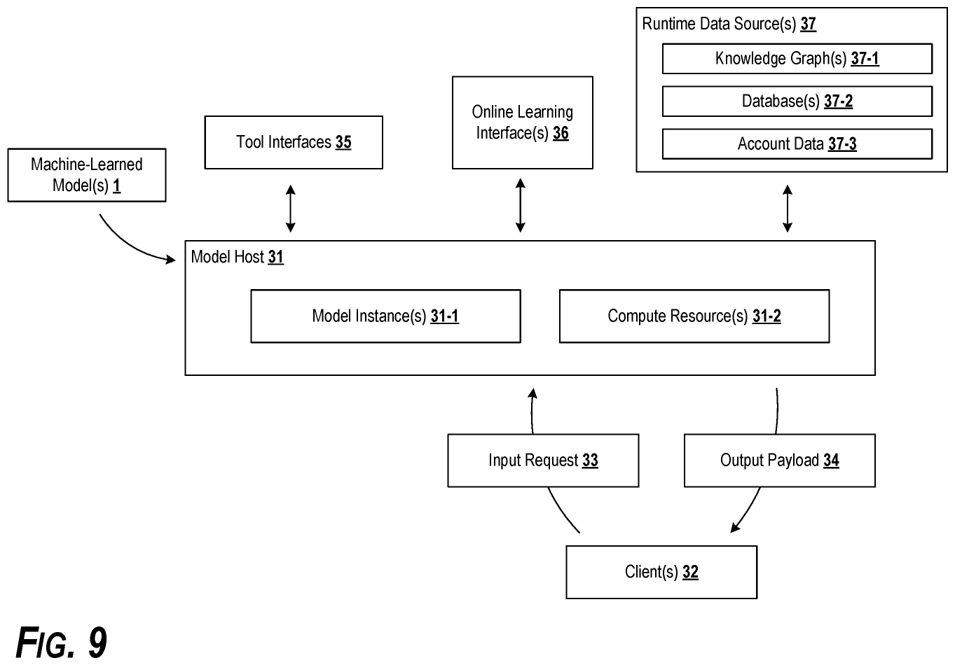

FIG. 9 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

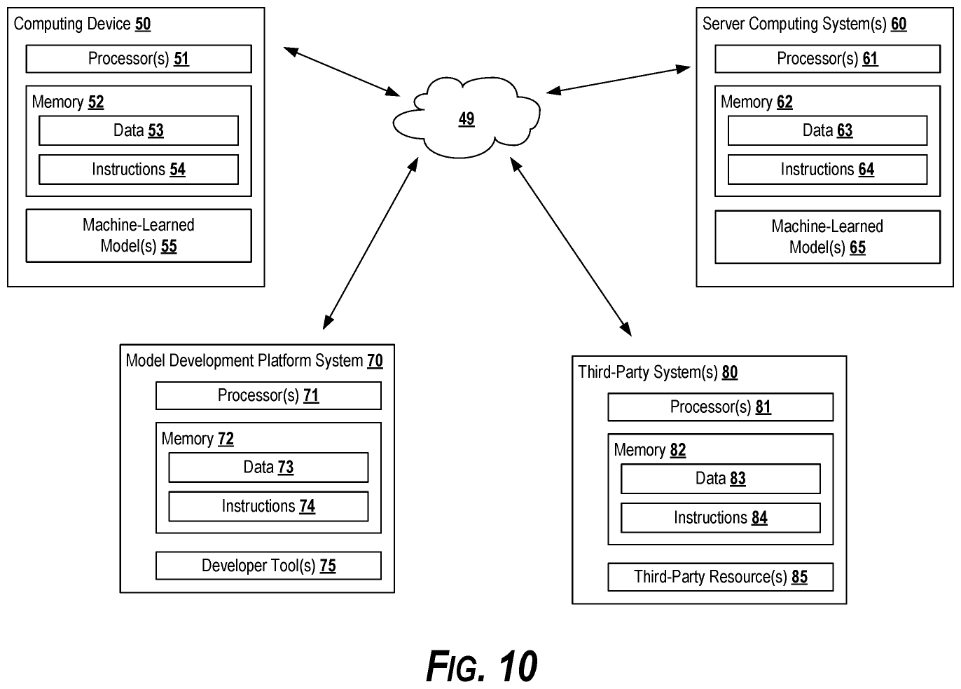

FIG. 10 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 10 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 10 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

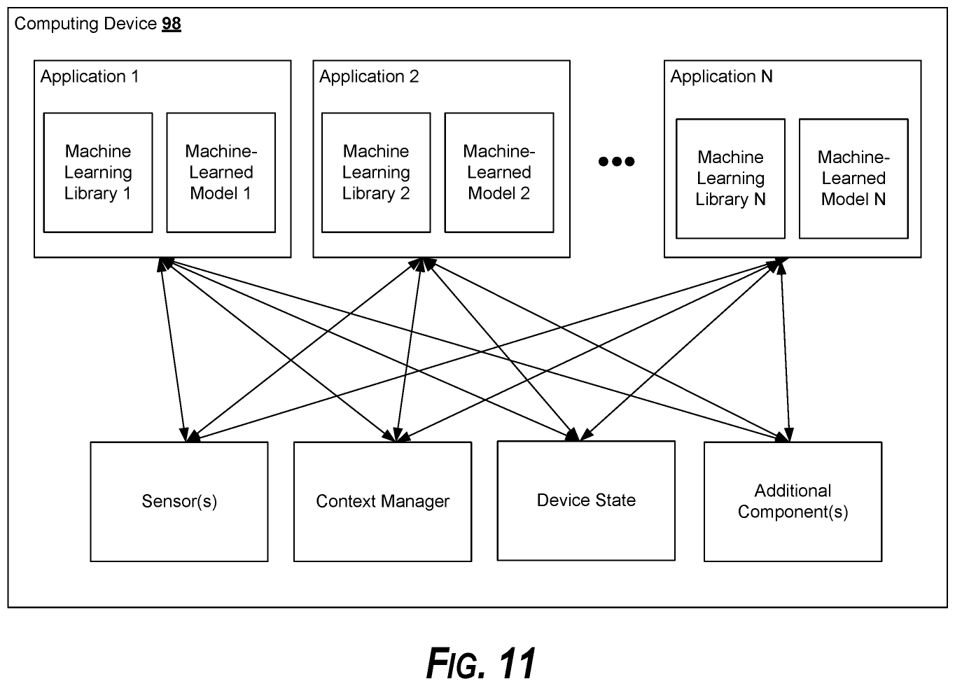

FIG. 11 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 11, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

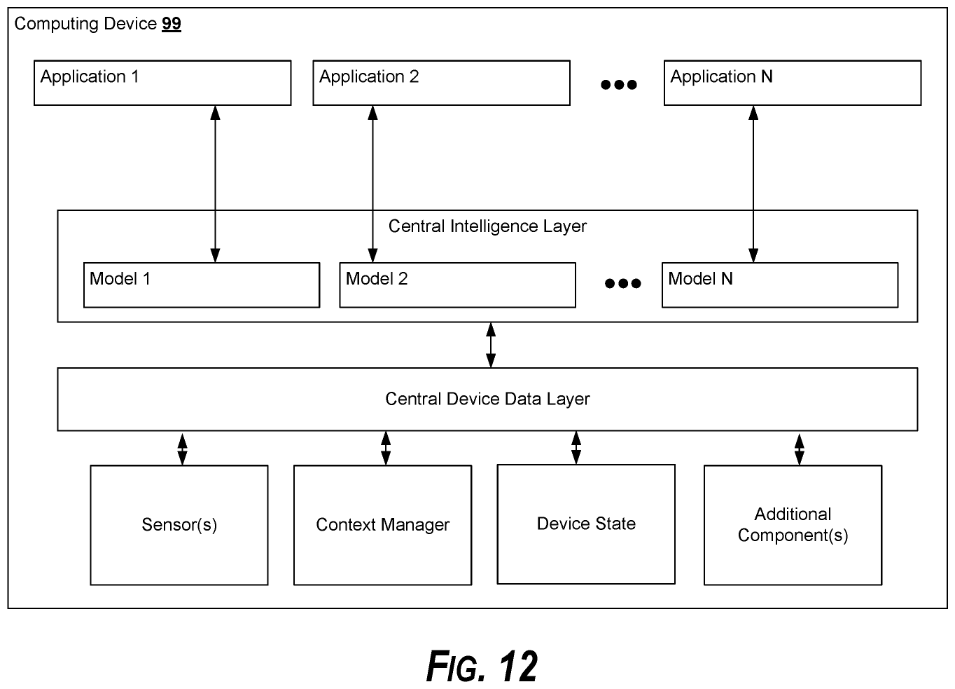

FIG. 12 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 12, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 12, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method for distilling a multi-sample preference sampling distribution into a student sequence processing model, the method comprising:
obtaining, by a computing system comprising one or more computing devices, a token sequence that is responsive to an input context;
determining, by the computing system, a student distribution of the student sequence processing model for the token sequence, wherein the student distribution characterizes a likelihood that the student sequence processing model generates the token sequence given the input context;
estimating, by the computing system and using the token sequence, the multi-sample preference sampling distribution for the token sequence, wherein the multi-sample preference sampling distribution characterizes a likelihood that the token sequence is returned by a multi-sample preference sampling process applied to a reference sequence processing model given the input context;
evaluating, by the computing system, a distribution matching loss that penalizes one or more divergence metrics between the student distribution and the multi-sample preference sampling distribution; and
modifying, by the computing system, one or more values of one or more parameters of the student sequence processing model based on the evaluating of the distribution matching loss.

2. The computer-implemented method of claim 1, wherein the multi-sample preference sampling process comprises:
generation of a plurality of candidate samples from the reference sequence processing model given the input context; and
application of a preference model to generate an output sample from the plurality of candidate samples.

3. The computer-implemented method of claim 2, wherein:
the multi-sample preference sampling process comprises a best-of-N sampling process; and
the application of the preference model in the best-of-N sampling process comprises:
evaluation of each of the plurality of candidate samples with a reward model to generate a reward score for each of the plurality of candidate samples, wherein the reward model has been trained on preference label data; and
selection of the candidate sample with the largest reward score as the output sample.

4. The computer-implemented method of claim 1, wherein the multi-sample preference sampling distribution comprises a reference sampling distribution associated with the reference sequence processing model times a reweighting term, wherein the reweighting term evaluates a preference value for the token sequence based on the preference model.

5. The computer-implemented method of claim 1, wherein the multi-sample preference sampling distribution comprises a best-of-N sampling distribution, and wherein the best-of-N sampling distribution comprises a reference sampling distribution associated with the reference sequence processing model times a reweighting term times a correction factor, wherein the reweighting term evaluates a reward quantile for the token sequence.

6. The computer-implemented method of claim 5, wherein estimating, by the computing system, the best-of-N sampling distribution for the token sequence comprises performing, by the computing system, a Monte Carlo estimate of the reward quantile for the token sequence.

7. The computer-implemented method of claim 6, wherein performing, by the computing system, the Monte Carlo estimate of the reward quantile for the token sequence comprises:
sampling, by the computing system, a number of random sequences from the reference sequence processing model; and
determining, by the computing system, the reward quantile for the token sequence based on an amount of the number of random sequences for which a reward generated for the token sequence by a reward model is greater than or equal to a respective reward generated for the random sequence by the reward model.

8. The computer-implemented method of claim 5, wherein estimating, by the computing system, the best-of-N sampling distribution for the token sequence comprises processing, by the computing system, the token sequence with a machine-learned quantile estimation model to generate an estimate of the reward quantile for the token sequence.

9. The computer-implemented method of claim 8, wherein the machine-learned quantile estimation model has been initialized from the reference sequence processing model.

10. The computer-implemented method of claim 8, wherein the machine-learned quantile estimation model has been trained using binary cross-entropy loss on actual reward outcomes.

11. The computer-implemented method of claim 8, wherein processing, by the computing system, the token sequence with the machine-learned quantile estimation model comprises determining, by the computing system, a sigmoid of a token-length-normalized sum of logit values of the reference sequence processing model for the token sequence.

12. The computer-implemented method of claim 1, wherein the one or more divergence metrics comprise one or more F-divergences.

13. The computer-implemented method of claim 1, wherein the one or more divergence metrics comprise a backward KL divergence metric between the student distribution and the multi-sample preference sampling distribution.

14. The computer-implemented method of claim 1, wherein the one or more divergence metrics comprise a Jeffrey's divergence metric between the student distribution and the multi-sample preference sampling distribution.

15. The computer-implemented method of claim 1, wherein evaluating, by the computing system, the distribution matching loss and modifying, by the computing system, the one or more values of the one or more parameters of the student sequence processing model based on the evaluating of the distribution matching loss comprises:
performing, by the computing system, a reinforcement learning algorithm to optimize the distribution matching loss.

16. The computer-implemented method of claim 1, wherein evaluating, by the computing system, the distribution matching loss and modifying, by the computing system, the one or more values of the one or more parameters of the student sequence processing model based on the evaluating of the distribution matching loss comprises:
performing, by the computing system, an offline regression algorithm to optimize the distribution matching loss.

17. The computer-implemented method of claim 1, wherein the method further comprises, while iteratively performing the operations of claim 1: periodically updating, by the computing system, the reference sequence processing model based on a current version of the student sequence processing model.

18. The computer-implemented method of claim 17, wherein periodically updating, by the computing system, the reference sequence processing model based on the current version of the student sequence processing model comprises periodically setting, by the computing system, the reference sequence processing model equal to the current version of the student sequence processing model.

19. The computer-implemented method of claim 17, wherein periodically updating, by the computing system, the reference sequence processing model based on the current version of the student sequence processing model comprises periodically updating, by the computing system, the reference sequence processing model based on a moving average of parameter values of the student sequence processing model.

20. The computer-implemented method of claim 19, wherein the moving average comprises an exponential moving average.

21. The computer-implemented method of claim 1, further comprising initializing, by the computing system, the student sequence processing model from the reference sequence processing model.

22. The computer-implemented method of claim 1, wherein the student sequence processing model has a smaller number of parameters than the reference sequence processing model.

23. A computing system configured to perform sequence processing model alignment, the computing system comprising one or more computing devices and configured to perform operations, the operations comprising:
obtaining a student sequence processing model;
performing a plurality of update iterations to update the student sequence processing model, wherein each of the update iterations comprises:
evaluating a distribution matching loss for one or more token sequences that are responsive to one or more context inputs, wherein the distribution matching loss seeks to minimize one or more divergence metrics between a student distribution that is associated with the student sequence processing model and a multi-sample preference sampling distribution that is representative of a multi-sample preference sampling process applied to a reference sequence processing model; and
modifying one or more values of one or more parameters of the student sequence processing model based on the evaluating of the distribution matching objective; and
periodically, while performing the plurality of update iterations, updating the reference sequence processing model based on a current version of the student sequence processing model.

24. The computing system of claim 23, wherein periodically updating, by the computing system, the reference sequence processing model based on the current version of the student sequence processing model comprises periodically setting, by the computing system, the reference sequence processing model equal to the current version of the student sequence processing model.

25. The computing system of claim 23, wherein periodically updating, by the computing system, the reference sequence processing model based on the current version of the student sequence processing model comprises periodically updating, by the computing system, the reference sequence processing model based on a moving average of parameter values of the student sequence processing model.

26. The computing system of claim 25, wherein the moving average comprises an exponential moving average.

27. One or more non-transitory computer-readable media that collectively store a student sequence processing model that has been trained by performance of training operations, the training operations comprising:
obtaining, by a computing system comprising one or more computing devices, a token sequence that is responsive to an input context;
determining, by the computing system, a student distribution of the student sequence processing model for the token sequence, wherein the student distribution characterizes a likelihood that the student sequence processing model generates the token sequence given the input context;
estimating, by the computing system and using the token sequence, a multi-sample preference sampling distribution for the token sequence, wherein the multi-sample preference sampling distribution characterizes a likelihood that the token sequence is returned by a multi-sample preference sampling process applied to a reference sequence processing model given the input context;
evaluating, by the computing system, a distribution matching loss that penalizes one or more divergence metrics between the student distribution and the multi-sample preference sampling distribution; and
modifying, by the computing system, one or more values of one or more parameters of the student sequence processing model based on the evaluating of the distribution matching loss.
